(19) United States
(12) Patent Application Publication
(10) Pub. No.: US 2008/0135646 A1
(43) Pub. Date: Jun. 12, 2008

(54) SYSTEM AND METHOD FOR A VACUUM INDUCING NOZZLE

(75) Inventor: ERNEST H. WILKINSON, HOUSTON, TX (US)

Correspondence Address: JESSICA W. SMITH, 1529 PARKVIEW DRIVE, GARLAND, TX, 75043, US

(73) Assignee: VACUUM INDUCING NOZZLE, LLC, HOUSTON, TX (US)

(21) Appl. No.: 11/952,860

(22) Filed: Dec. 7, 2007

Related U.S. Application Data
(63) Continuation-in-part of application No. 11/608,824, filed on Dec. 9, 2006.

(51) Int. Cl. B05B 7/06

(52) U.S. Cl. 239/432

(57) ABSTRACT

A nozzle has a cylindrical conduit section with a power fluid inlet, an outlet and a pumped fluid inlet at a location between the power fluid inlet and the outlet; a straightening vane plate sealed across the power fluid inlet including a plurality of straightening vanes situated around a pass thru conduit; a wing support and tube attached to the straightening vane plate that provides a passageway for the power fluid pass thru conduit and extends across the pumped fluid inlet; and a circular wing structure attached to an end of the wing support and tube, wherein the circular wing structure has a nosed shaped profile. The nosed shaped profile has a first face having an outer diameter larger than the wing support and tube and a rounded portion with a slope that decreases to almost parallel to the walls of the cylindrical section. The circular wing structure then has a tapering portion that tapers down again to a diameter similar to the wing support and tube. The tip of the circular wing structure forms an opening or power fluid outlet for the power fluid pass thru conduit. In an alternate embodiment, rather than a straightening vane plate, the cylindrical conduit includes a tapered section that forms a narrow opening in the cylindrical conduit upstream from the pumped fluid inlet. A power fluid conduit extends through the narrow opening in the tapered section and across the pumped fluid inlet.

### CROSS REFERENCE TO RELATED PATENTS

This U.S. patent application claims priority as a continuation in part application under 35 U.S.C. § 120 to co-pending U.S. patent application Ser. No. 11/608,824, entitled, “System and Method for A Vacuum Inducing Nozzle,” to Ernest Wilkinson, filed on Dec. 9, 2006, which is hereby incorporated by reference.

### BACKGROUND OF THE INVENTION

1. Technical Field of the Invention

This invention relates to nozzles, and more particularly nozzles that include at least one pumped fluid inlet.

2. Description of the Related Art

A typical nozzle for a fluid flow includes a housing with a high pressure power inlet to a generally cylindrical conduit, wherein fluid, either a liquid or a gas or a mixture thereof, at a high pressure passes into the power fluid inlet and flows through the cylindrical conduit along an axis in parallel to the walls of the cylindrical conduit. The cylindrical conduit has an outlet downstream from the power inlet for flow of the fluid into another line or container or the air.

A modified jet pump was described in prior U.S. Pat. No. 5,454,696, entitled, “Vacuum Inducing Pump.” As shown in FIG. 1, the description of this jet pump 10 includes a power fluid inlet 12, a generally cylindrical conduit section 14 and an outlet 16 spaced downstream from the power inlet. In addition, the jet pump includes a pumped fluid inlet 18 including a conduit 20 opening into the cylindrical conduit section 14 at a location between the power fluid inlet 12 and the outlet 16. Extending across the pumped fluid inlet 18 is a power fluid inlet structure 22 that has a first plate 24 sealed relative to the power fluid inlet. A small power fluid inlet conduit 26 having a passage begins at the first plate 24 and goes through a second plate 26. The second plate 26 is likewise sealed against the conduit section 14 downstream from the pumped fluid inlet 18. The second plate 28 provides a plurality of passages 30 for providing communication between the pumped fluid inlet 18 and downstream of the power fluid inlet structure 22.

In use, a relatively high pressure fluid, either gas, liquid or a mixture thereof, passes through the power fluid inlet 12 into the power fluid inlet conduit 26. As the volume decreases, the velocity of the fluid increases substantially and the pressure in the housing adjacent the downstream end of the second plate 28 is thereby lowered substantially. This creates a low pressure area open to the pumped fluid inlet 18 inducing flow of a pumped fluid into the housing. Downstream of the second plate, the power fluid and pumped fluid comingle and then pass through the outlet 16. One or more diffusers 32 may also be used to slow down the fluid flow and raise the pressure of the comingled stream.

This known jet pump directs all flow of the power fluid through the small power fluid conduit 26. The power fluid and pumped fluid do not mix until after the second plate 28. This known jet pump has disadvantages in efficiency for certain applications.

Thus, an improved method for creating a low pressure area around the pumped fluid inlet and for mixing the power fluid and pumped fluid is needed.

### BRIEF SUMMARY OF THE INVENTION

The present invention is directed to apparatus and methods of operation that are further described in the following Brief Description of the Drawings, the Detailed Description of Embodiments of the Invention, and the claims. Other features and advantages of the present invention will become apparent from the following detailed description of embodiments of the invention made with reference to the accompanying drawings.

### BRIEF DESCRIPTION OF THE SEVERAL VIEWS OF THE DRAWINGS

For a more complete understanding of the present invention, and the advantages thereof, reference is now made to the following descriptions taken in conjunction with the accompanying drawings, in which:

FIG. 1 illustrates an existing jet pump system.

FIGS. 2a, 2b and 2c illustrate an embodiment of the nozzle of the present invention.

FIGS. 3a, 3b and 3c illustrate an embodiment of the nozzle of the present invention.

FIG. 4 illustrates use of an embodiment of the nozzle in a well system.

FIG. 5 illustrates use of an embodiment of the nozzle in a system for cleaning oil spills.

FIG. 6 illustrates use of an embodiment of the nozzle in an air conditioning system.

FIG. 7 illustrates an embodiment of the nozzle of the present invention.

FIG. 8 illustrates use of an embodiment of the nozzle in an engine system.

FIGS. 9a, 9b, 9c and 9d illustrate an embodiment of the nozzle of the present invention.

FIGS. 10a and 10b illustrate an embodiment of the nozzle of the present invention.

### DETAILED DESCRIPTION OF EMBODIMENTS OF THE INVENTION

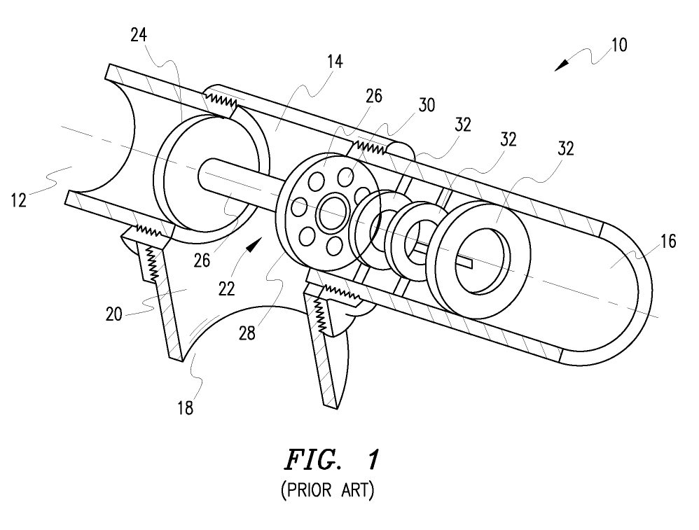

The present invention is best understood in relation to FIGS. 1 through 10 of the drawings, like numerals sometimes being used for similar elements of the various drawings. The following description includes various specific embodiments of the invention but a person of skill in the art will appreciate that the present invention may be practiced without limitation to specific details described herein.

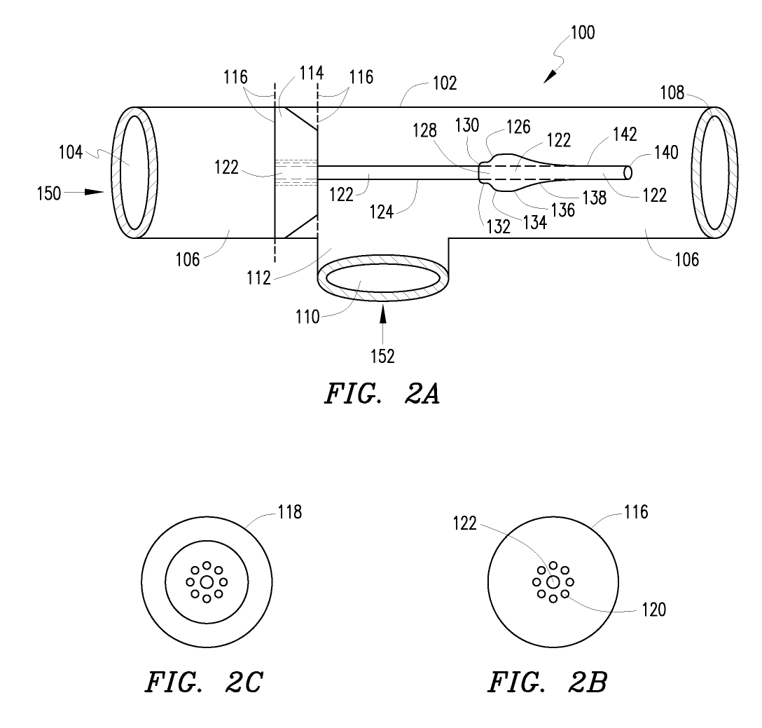

FIG. 2 illustrates one embodiment of the nozzle 100 of the present invention. As shown in FIG. 2, the nozzle 100 in this embodiment of the invention includes a housing 102 having a power fluid inlet 104, a generally cylindrical conduit 106 and an outlet 108 spaced downstream from the power fluid inlet 104. In addition, the nozzle 100 includes a pumped fluid inlet 110 including a conduit 112 opening into the cylindrical conduit 106 at a location between the power fluid inlet 104 and the outlet 108. Extending across an opening provided by the power fluid inlet 104 is a straightening vane plate 114 structure that is sealed relative to the power fluid inlet 104. To illustrate the structure of the straightening vane plate 114, a first face 116 of the plate 114 is shown in FIG. 2b and a second face 118 of the plate 114 is shown in FIG. 2c.

As shown in FIG. 2b, the first face 116 of the straightening vane plate 114 is preferably circular to provide a seal along the walls of the cylindrical conduit 106. The straightening vane plate 114 includes a plurality of small conduits or straightening vanes 120 that run through the straightening vane plate 114. These straightening vanes 120 are situated about a pass thru conduit 122. In a preferred embodiment, the pass thru conduit 122 runs from the center of the first face 116 to the center of the second face 118. The straightening vanes 120 are positioned around the pass thru conduit 122 and closer to the pass thru conduit 122 than the circumference of the faces 116 or 118. The pass thru conduit 122 has a slightly larger diameter than the straightening vanes 120.

The straightening vane plate 114 tapers to a smaller diameter second face 118. FIG. 2c illustrates the second face 118 of the straightening vane plate 114. At the second face 118, the straightening vanes 120 open into the cylindrical conduit 106. However, the pass thru conduit 122 continues through a wing support and tube 124. The wing support and tube 124 is welded into or screwed into the straightening vane plate 114. The wing support and tube 124 provides a tube or passageway or conduit for the pass thru conduit 122. The wing support and tube 124 preferably extends across the pumped fluid inlet 110 and is roughly in the center of the cylindrical conduit 106.

Downstream from the pumped fluid inlet 110, the wing support and tube 124 is connected to a circular wing structure 126. The circular wing structure 126 preferably has a nosed shaped profile 128 with a first face 130 having an outer diameter larger than the wing support and tube 124. The nosed shaped profile 128 then has a rounded portion 132 with a slope that decreases to almost parallel to the conduit walls. Then the nosed shaped profile 128 has an expanding portion 134 that sharply slopes up again before leveling to a parallel 136 with the conduit section 106. After the nosed shaped profile 128, the circular wing structure 126 then has a tapering portion 138 that tapers down again to a diameter similar to the wing support and tube 124.

The wing structure 126 forms an inner tube or passageway for the pass thru conduit 122. The tip 142 of the circular wing structure 126 forms an opening or power fluid outlet 140 for the pass thru conduit 122. Thus, in the embodiment of FIG. 2, the pass thru conduit 122 extends through the straightening vane plate 114, through the wing support and tube 124 and the circular wing structure 126. It preferably has a roughly constant diameter throughout each structure.

FIG. 2 shows example dimensions that are for illustrative purposes of one embodiment of the nozzle. These example dimensions are not limiting to other embodiments of the nozzle and may be varied depending on application of the nozzle within the ability of a person of average skill in the art.

In operation, a high pressure power fluid, either a liquid, gas or combination thereof, flows into the power fluid inlet 104 from a pump, high pressure well or other source. At the straightening vane plate 114, since it is sealed against the walls of the conduit section 106, the power fluid 150 is forced into the straightening vanes 120 and the pass thru conduit 124. Since the power fluid 150 passes through a decreasing area, the velocity of the power fluid 150 increases. With increasing flow velocity of the power fluid 150, the pressure decreases. A portion of the volume of the power fluid 150 flows through the pass thru conduit at a high velocity and exits at the power fluid outlet 140. The remaining volume of the power fluid 150 flows through the straightening vanes 120. As this volume of power fluid 150 exits the straightening vanes at a high velocity, due to viscous friction, a boundary layer of the power fluid 150 keeps the flow along the outside of the wing support and tube 124. This high velocity fluid creates a low pressure area around the pumped fluid inlet 110 drawing a pumped fluid 152, either liquid or gas or mixture thereof, into the conduit 112 and cylindrical conduit 106.

Then, when the power fluid 150 flow reaches the circular wing 126 at a high velocity, it impinges on the nosed shaped profile 128 and quickly decreases in velocity as it spreads across the entire volume of the conduit section 106. As the fluid hits the sides of the conduit section 106, it circulates back around creating a circular flow around the mid section of the circular wing 126. This circular flow creates an area ideal for mixing the power fluid 150 and pumped fluid 152. The mixture of the power fluid 150 and pumped fluid 152 is further facilitated by the high velocity stream of a portion of the power fluid 150 exiting at the power fluid outlet 140.

The embodiment of the nozzle 100 has advantages over the known jet pump shown in FIG. 1. In the known jet pump of FIG. 1, all the power fluid was passed through a conduit to the downstream side of the pumped fluid inlet 110. In this embodiment of the nozzle 100, some volume of the power fluid 150 flows through straightening vanes 120 into the cylindrical conduit 106 and over the pumped fluid inlet. In addition, the nosed shaped profile of the circular wings improves the quick expansion of the power fluid 150 and mixture of the power fluid 150 and pumped fluid 152.

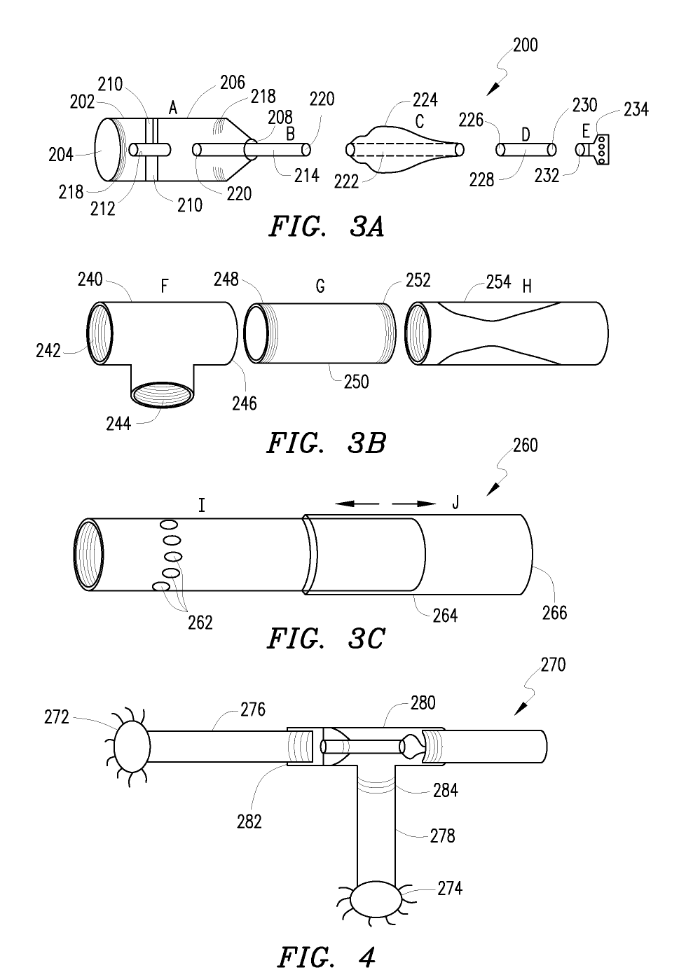

FIGS. 3a, 3b and 3c illustrate another embodiment of a nozzle 200 of the present invention. FIG. 3a illustrates a first portion of the nozzle 200 in this embodiment of the invention. As seen in FIG. 3a, a power fluid inlet housing 202 having a power fluid inlet 204 includes a generally cylindrical portion 206 that tapers to a narrow power fluid outlet 208 spaced downstream from the power fluid inlet 204. Thus, the power fluid inlet housing 202 includes a tapered section that forms the narrow power fluid outlet 208. In addition, power fluid inlet housing 202 includes one or more supports 210 that support a first power fluid conduit 212. The supports 210 and power fluid conduit 212 are welded to or molded as part of the power fluid inlet housing 202.

The first power fluid conduit 212 is roughly in the center of the housing 202. The first power fluid conduit 212 attaches to a second power fluid conduit 214 by threads 220 that screw into the end of the first power fluid conduit 212. The second power fluid conduit 214 extends through the power fluid outlet 208. A small ring shaped opening is formed between the tapered section of the power fluid outlet 208 and the power fluid conduit. The second power fluid conduit 214 attaches to a circular wing structure 224 by threads 220. The circular wing structure 224 is similar in design to the circular wing structure 126 of FIG. 2a. The circular wing structure 224 also includes a conduit that forms an extension to the power fluid conduits 212 and 214. In FIG. 3a, this extension is labeled as third power fluid conduit 222. Thus, the power fluid may flow through the first power fluid conduit 212 to the second power fluid conduit 214 and through to the third power fluid conduit 222 formed by the circular wing structure 126.

An optional fourth power fluid conduit extension 228 can be attached to the circular wing structure 224 as needed for certain applications. The extension 228 allows for the power fluid to flow from the third power fluid conduit 222 formed by the circular wing structure 126 to the power fluid outlet 230. In some embodiments as explained below, a sprayer head 234 may be attached to the fourth power fluid conduit extension 228 by threads 232.

FIG. 3b illustrates another portion of the nozzle 200 in this embodiment of the invention. A T-shaped conduit 240 includes a power fluid inlet 242, a pumped fluid inlet 244 and fluid outlet 246. The T-shaped conduit 240 attaches to the power fluid housing 202 by threads 218. When attached in the preferred embodiment of the present invention, the second power fluid conduit 214 extends over the pumped fluid inlet 244 such that the power fluid outlet 208 of the power fluid housing 202 is upstream of the pumped fluid inlet 244 and the circular wing structure 224 is downstream of the pumped fluid inlet 244. A housing extension 250 is attached by threads 248 to the fluid outlet 246 of the T-shaped conduit 240. The housing extension 250 is of sufficient length to enclose the circular wing structure 224 and power fluid conduit extension 228. In addition, an optional nozzle piece 254 may be attached to the housing extension 250 by threads 252.

In operation of an embodiment of the invention, the first T-shaped conduit 240 is attached to the power fluid housing 202 and the housing extension 250. Within the enclosure formed by the power fluid housing 202, T-shaped conduit 240 and the housing extension 250, the second power fluid conduit 214 is attached to the first power fluid conduit 212 and the circular wing structure 224. The second power fluid conduit 214 extends over the pumped fluid inlet 244 such that the power fluid outlet 208 of the power fluid housing 202 is upstream of the pumped fluid inlet 244 and the circular wing structure 224 is downstream of the pumped fluid inlet 244. A fourth power fluid conduit extension 228 is attached to the circular wing structure 224 within the housing extension 250 as well.

A high pressure power fluid 150, either a liquid, gas or combination thereof, flows into the power fluid inlet 204 from a pump, high pressure well or other source. A small portion of the power fluid 150 is forced into the first power fluid conduit 212. The remaining portion of the power fluid 150 is forced through the ring shaped opening between the tapered section at the power fluid outlet 208 of the power fluid housing 202 and the second power fluid conduit 214. Since the power fluid 150 passes through a decreasing area in the tapered section, the velocity of the power fluid 150 increases. As this volume of power fluid 150 exits the ring shaped opening at the power fluid outlet 208, due to viscous friction, a boundary layer of the power fluid 150 keeps the flow along the outside of the second power fluid conduit 214. This high velocity power fluid creates a low pressure area around the pumped fluid inlet 244 drawing a pumped fluid 152, either liquid or gas or mixture thereof, into the T-shaped conduit 240.

Then, when the power fluid 150 flow reaches the circular wing 224 at a high velocity, it impinges on the nosed shaped profile and quickly decreases in velocity as it spreads across the entire volume of the conduit. As the fluid hits the sides of the conduit, it circulates back around creating a circular flow around the mid section of the circular wing 224. This circular flow creates an area ideal for mixing the power fluid 150 and pumped fluid 152. To increase the velocity of the mixture, the optional nozzle piece 254 may be attached to the housing extension 250. The nozzle piece 254 reduces the area and increases the velocity of the mixture of the power fluid 150 and pumped fluid 152. This increase in velocity is further facilitated by the high velocity stream of a portion of the power fluid 150 exiting the fourth power fluid conduit extension 228.

FIG. 3c illustrates another embodiment of the nozzle. In this embodiment, a nozzle housing 260 is attached to the power fluid housing 202 by threads 218. The nozzle housing 260 includes a ring of openings 262. The ring of openings 262 are formed in a ring around a circumference of the nozzle housing 260. The nozzle housing 260 also includes an adjustable extension 264. The adjustable extension is attached so that it may slide back or retract to shorten the nozzle housing 260 or to slide forward or extend to lengthen the nozzle housing 260. The adjustable extension 264 includes one or more latches or other mechanisms to secure the extension into place in either the extended or retracted position.

In operation of this embodiment of the nozzle, the second power fluid conduit 214 preferably extends across the ring of openings 262 when it is attached to the first power fluid conduit 212. The circular wing structure 224 is preferably downstream from the ring of openings 262 when attached to the second power fluid conduit 214. In addition for certain applications, the sprayer head 234 is preferably attached to the fourth power fluid conduit extension 228 which is attached to the circular wing structure 224. The sprayer head 234 preferably extends outside of the nozzle housing outlet 266 when the adjustable extension 264 is retracted. When extended, the adjustable extension preferably encloses the sprayer head 234.

This embodiment of the nozzle in FIG. 3c is ideal for a fire hose. For example, in use, high pressure water or other fluid is pumped into the power fluid inlet 204. A small portion of the water is forced into the first power fluid conduit 212. The remaining portion of the water is forced through the ring shaped opening between the tapered section at the power fluid outlet 208 of the power fluid housing 202 and the second power fluid conduit 214. Since the water passes through a decreasing area, the velocity of the water increases. As this volume of power fluid 150 exits the narrow power fluid outlet 208, due to viscous friction, a boundary layer of the water keeps the flow along the outside of the second power fluid conduit 214. This high velocity water creates a low pressure area around the ring of openings 262 drawing air into the nozzle housing 262.

Then, when the power fluid 150 flow reaches the circular wing 224 at a high velocity, it impinges on the nosed shaped profile and quickly decreases in velocity as it spreads across the entire volume of the conduit. As the fluid hits the sides of the conduit, it circulates back around creating a circular flow around the mid section of the circular wing 224. This circular flow creates a high pressure area ideal for mixing the water and air. To increase the velocity of the mixture, the sprayer head 234 is attached to the fourth power fluid conduit 228. The high velocity stream of a portion of the power fluid 150 exiting the fourth power fluid conduit extension 228 enters the sprayer head 234. The centrifugal force of the water because of the angle and position of the exit holes in the sprayer head 234 makes the sprayer head 234 rotate. For a broad spray of water, the adjustable extension 264 is retracted such that the sprayer head is positioned outside of the outlet 266. This broad spray is more ideal for a heat screen for entry to a burning area. For a more concentrated spray to an isolated area, the adjustable extension 264 is extended over the sprayer head 234 and locked into place. The adjustable extension 264 directs the water flow to a more concentrated area. The higher velocity water from the sprayer head 234 also helps to extend the reach of the water. This ability to quickly adjust the area of coverage of the water is ideal for fighting large fires where different capabilities may be quickly needed depending on the situation faced by a firefighter.

The above described embodiments of the nozzle have many other applications in different fields of endeavor. A few such applications are described with respect to FIGS. 4 through 6 below, though such applications are not exhaustive.

FIG. 4 illustrates use of the nozzle 280 in a well system 270, for example a gas or oil well system. The embodiment of the nozzle 280 in FIG. 4 may be similar to the embodiment of the nozzle 100 in FIG. 2 or the embodiment of the nozzle 200 in FIGS. 3a and 3b though other embodiments and variations within the scope of the claims may also be used. The power fluid inlet 282 of the nozzle 280 is connected to a well 272 through a flow line 276. The pumped fluid inlet 284 is connected to well 274 through a flow line 278. The fluid, gas or liquid or mixture thereof, in well 272 is at higher pressure and/or produces a larger quantity of fluid than the well 274. As explained above, the nozzle 280 creates a low pressure region over the pumped fluid inlet 284 and thus increases the flow of the fluid from well 274.

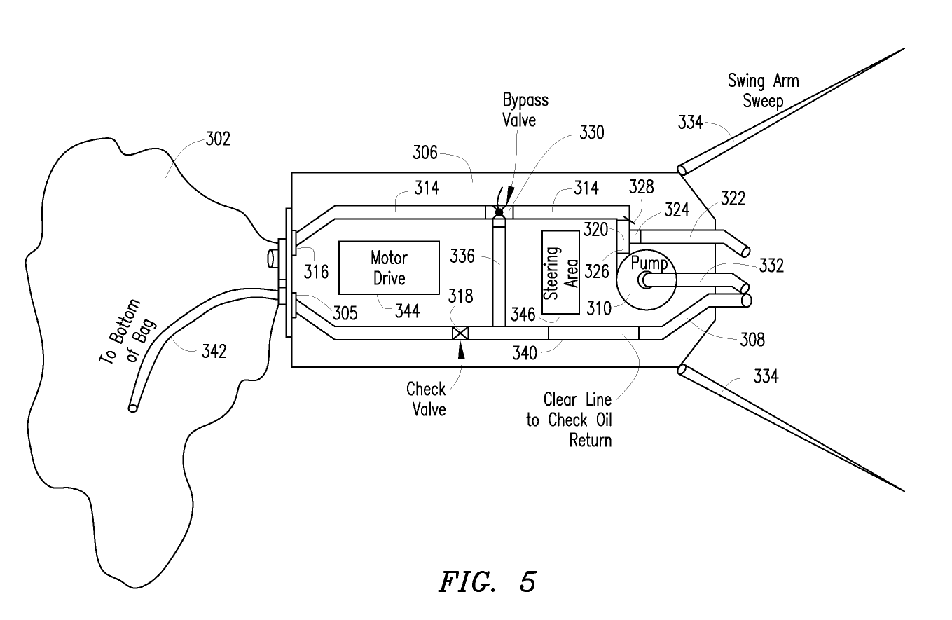

FIG. 5 illustrate use of the nozzle in a system 300 for cleaning oil spills in a body of water, such as a bay, gulf, sea, etc. . . . The FIG. 5a illustrates a top view of a boat 306 with a steering area 346 and motor drive 344. A large collection bag 302 is connected to the back of the boat 306. The bag 302 includes a discharge outlet 305 and bag inlet 316. Preferably the discharge outlet 305 and bag inlet 316 are shaped differently to correspond to the correct hoses to avoid incorrect installation. The discharge outlet 305 is located at the bottom of the bag 302 and is connected by water discharge line 308 outside of the boat. The pump 310 is connected to water inlet house 332 and to the power fluid inlet 326 of nozzle 320. The embodiment of the nozzle 320 may be similar to the embodiment of the nozzle 100 in FIG. 2 or the embodiment of the nozzle 200 in FIGS. 3a and 3b though other embodiments and variations thereof may also be used.

A collection hose 322 is connected to the pumped fluid inlet 324 of the nozzle 320. A delivery hose 314 is connected to the outlet 328 of the nozzle 320 and to an upper bag inlet 316. A bypass valve 330 is connected to a bypass hose 336 between the delivery hose 314 and the water discharge line 308. A check valve 318 is located in the water discharge hose 308 upstream of the connection to the bypass hose 336. Two swing arm sweeps 334 are connected to the front of the boat to aid in collection of the oil/water mixture. The swing arm sweeps 334 may be stationary or may be able to rotate to help consolidate the oil at the front of the boat 306.

In operation, water and oil is pumped from the body of water through a floating inlet hose 332 by pump 310. The pumped, high pressure water flows through power fluid inlet 326 of nozzle 320 creating a low pressure area over the pumped fluid inlet 324. The oil to be removed is drawn through the floating inlet hose 322 into the pumped fluid inlet 324 by this low pressure. The circular wing structure in the nozzle 320 slows down the water from the pump 310 and helps to draw the oil/water being collected. This oil/water mixture flows through delivery hose 314 to upper bag inlet 316. The oil in the oil/water mixture floats to the top of the bag 302 while the water falls to the bottom to be discharged through a water discharge line extension 342 through discharge outlet 305 to water discharge line 308. When enough oil is collected to fill a bag, then oil will be discharged from discharge outlet 305 to water discharge line 308. The discharge line 308 includes a clear sight tube 340 near the operator's position so he can observe the oil in the water discharge line 308. Other mechanisms may also be used to detect oil in the water discharge line 308. This presence of oil in the discharge line 308 indicates that the bag 302 is full of oil and needs to be changed. The operator manually or other mechanism may automatically activate the bypass valve 330. The bypass valve 330 switches the flow of the oil/water mixture from the delivery hose 314 through the bypass hose 336 to the discharge hose 308. The check valve 318 prevents the flow of oil/water mixture from the bypass hose 336 to the discharge outlet 305. The bag 302 that is now filled with oil can then be sealed and another bag installed to collect more oil.

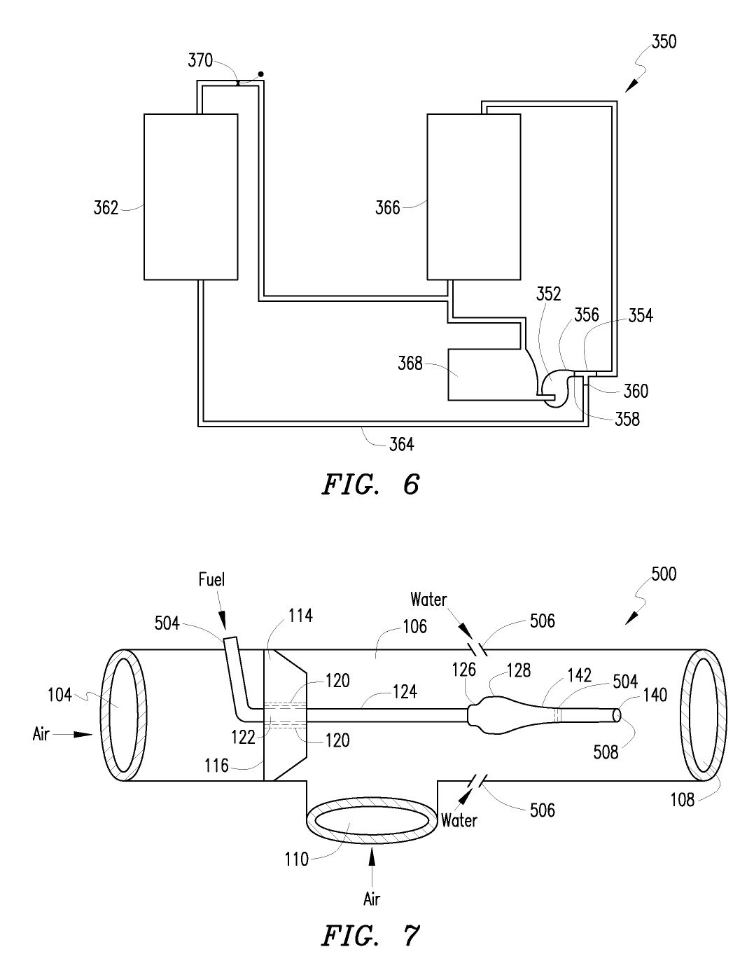

FIG. 6 illustrates an application of the nozzle in an air conditioning system 350. The most expensive part of most air conditioners is the compressor. In this embodiment of the invention, the compressor is replaced by a pump 352 and the nozzle 354. The embodiment of the nozzle 354 in FIG. 6 may be similar to the embodiment of the nozzle 100 in FIG. 2 or the embodiment of the nozzle 200 in FIGS. 3a and 3b though other embodiments and variations thereof may also be used. The pump 352 is connected by a pump line 356 to the power fluid inlet 358 of the nozzle 354. The pumped fluid inlet 360 of the nozzle 354 is connected to an outlet of an inside exchanger or cooling coils 362 by hose 364. The inside exchanger 362 are filled with a refrigerant, such as water, ammonia, Freon or any other expandable fluid. In the inside exchanger 362, the Freon gas is cool and at a low pressure and absorbing the heat from the air inside. The pump 352 and nozzle 354 create a low pressure area around the pumped fluid inlet 360 drawing in the Freon gas from inside exchanger 362. The gas is then compressed by the nozzle 354. The gas becomes hotter with increased pressure. The hot gas flows through the outside exchanger 366 which includes heat dissipating coils so it can dissipate its heat, and condenses into a liquid. This cool liquid flows to reservoir 368 back through pump 352 to the nozzle 354. Another part of the Freon liquid runs through an expansion or needle valve 370, and in the process it expands and evaporates to become cold, low-pressure Freon gas that flows through the inside exchange 362. Thus, this cold Freon gas absorbs heat and cools down the air around the cooling coils in the inside exchange 362 before being drawn back into the pumped fluid inlet 360 of nozzle 354.

FIG. 7 illustrates another embodiment of the nozzle. The nozzle 500 shown in FIG. 7 is similar to the nozzle 100 in FIG. 2, but a person of skill in the art would understand that the nozzle 200 in FIGS. 3a and 3b may also be used as well. In this embodiment, a fuel injector hose 504 is connected to the pass thru conduit 122 at the first face 116 of the straightening vane plate 114. In the circular wing structure 126, the outlet 104 is shut by a cap 508 or welded shut. The circular wing tip 142 includes a plurality of fuel openings 504. The nozzle 500 also includes one or more water intake valves 506 in the conduit section 106 around the circular wing 126.

The nozzle 500 may be used for various applications such as a steam generator. For the steam generator, high pressure air is forced into the power fluid inlet 104. Since the opening to the pass thru conduit 122 is closed by the fuel injector tube 504, all the pressurized air flows through the straightening vanes 120. As this compressed air exits the straightening vanes at a higher velocity, a low pressure area is created around the pumped fluid inlet 110. This low pressure area induces flow of a fluid through the pumped fluid inlet 110. The fluid may be additional air or a catalyst depending on the desired application. Then, when the air flow reaches the circular wing 126 at a high velocity, it impinges on the nosed shaped profile 128 and decreases in velocity as it spreads across the entire volume of the conduit section 106. As the air hits the sides of the conduit section 106, it circulates back around creating a circular flow around the mid section of the circular wing 126. In addition, water is introduced into the cylindrical conduit 106 from one or more of the water intake valves 506 at the mid section of the circular wing 126. This circular flow of air creates a high pressure area ideal for mixing the air and water. At the same time, fuel is injected in the fuel injector 504. The fuel may be a gas or liquid or mixture thereof. For example, the fuel may be ethanol or hydrogen gas. The fuel is forced through the fuel openings 504 and quickly expands releasing heat into the air and water mixture. This air and water mixture is thus quickly heated into steam. The steam flows out the outlet 108.

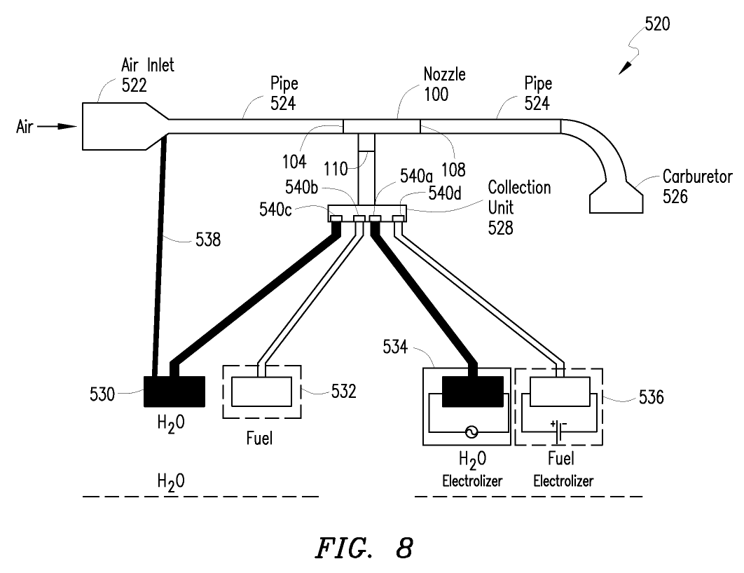

FIG. 8 illustrates use of an embodiment of the nozzle 100 in an engine system 520. In this application, the nozzle 100 blends air and fuel, e.g. for an internal combustion engine. The engine system 520 includes an air inlet 522, a pipe 524, the nozzle 100 and carburetor or other fuel injector 526. The engine system 520 also a collection unit 528 with valves 540a-d. The valves 540 may be adjustable, such as needle valves, or each may be a same or different preset circumference to allow a certain amount of fluid to enter the collection unit. Water supply 530 is coupled to valve 540a and a water electrolizer to supply hydrogen and oxygen gas may be coupled to valve 540c. In addition, a fuel supply 532 may be connected to valve 540b and a fuel electrolizer connected to valve 540d. For example, the fuel may be ammonia or gasoline.

In operation, the air flows through the air inlet and into the power fluid inlet of the nozzle 100. As the air enters the power fluid inlet 104 of the nozzle, a low pressure area is created around the pumped fluid inlet 110 which draws the fluid in the collection unit into the nozzle 100 to be mixed with the air. The rate of flow of air through the nozzle 100 may be varied and thus vary the pressure induced in the nozzle 100 around the pumped fluid inlet 110. As such, the quantity of air/fuel mixture that the engine system 520 will deliver may be controlled. As the air flow is increased, the induced pressure is lower increasing the flow of the air/fuel mixture. The engine power can thus be increased or decreased by controlling the air flow through the nozzle. In addition, the amount of fuel in the air/fuel mixture may be altered using the valves 540.

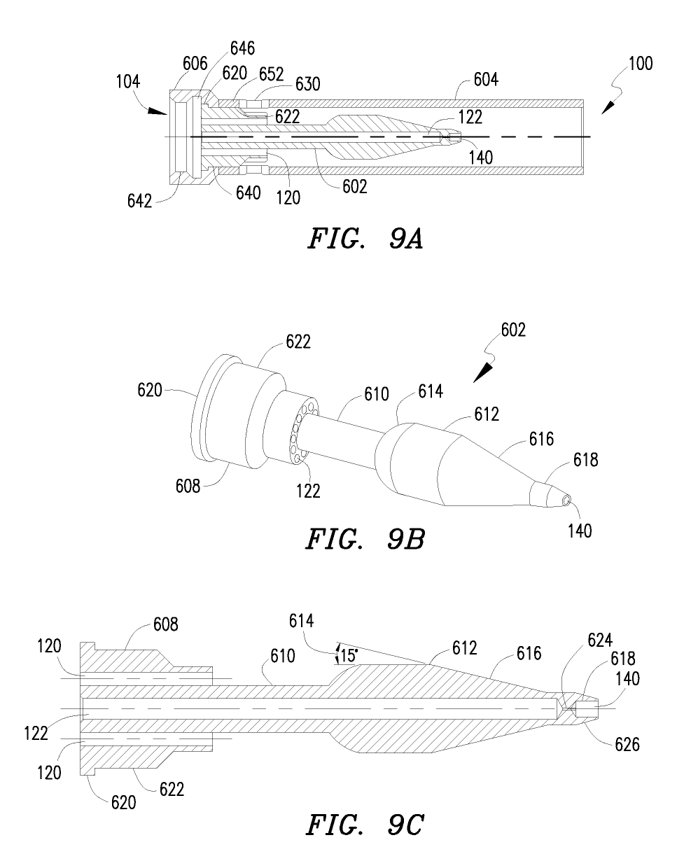

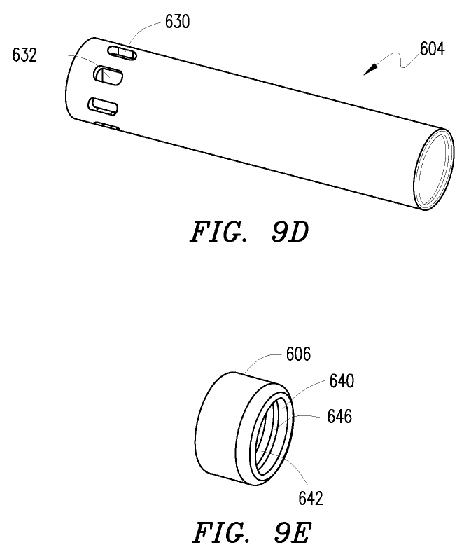

FIGS. 9a, b, c and d illustrate another embodiment of the nozzle 100. The embodiment of the nozzle 100 in FIG. 9a comprises a center piece 602, a housing 604 and a hose attachment 606. In this embodiment, the center piece 602, the support piece 610 and the circular wing structure 612 are a single part, though in other embodiments these parts may be manufactured as separate parts. Sample dimensions of the nozzle 100 shown in FIG. 9a are exemplary of one embodiment of the nozzle 100. Other scales of the shown dimensions or different dimensions from those illustrated of the various parts may be implemented depending on the embodiment and/or application of the nozzle 100.

The center piece 602 is shown in more detail in FIGS. 9b and 9c. The centerpiece 602 includes a straightening vane piece 608, a support piece 610 that extends from a first end of the straightening vane piece and a circular wing structure 612 at a second end of the support piece 610. In this embodiment of the nozzle 100, the straightening vane piece 608, support piece 610 and circular wing structure 612 are one part though in other embodiments, the centerpiece 602 may be constructed of one or more parts that are operable to perform the described functions of the centerpiece 602.

The straightening vane piece 608 includes a lip 620 that extends outward at one end such that the lip 620 is operable for coupling the center piece 602 to the hose attachment 606. In addition, the straightening vane piece 608 also includes threads 622 for coupling the center piece 602 to the housing 604. In one embodiment, the centerpiece 602 includes a plurality of straightening vanes 120 and a pass thru conduit 122. In an alternate embodiment, the centerpiece 602 does not include a pass thru conduit 122. In another embodiment, one end or portion of the pass thru conduit 122 is obstructed to prevent the flow of fluid through the pass thru conduit 122.

As shown in FIGS. 9b and 9c, the circular wing structure 612 comprises a nosed shaped profile 614 and a conical tapering portion 616. In addition, in one embodiment, the circular wing structure also includes an end portion 618. The circular wing structure 612 forms an internal hour glass shape 624 in the pass thru conduit 122 approximate to or internal to this end portion 618 of the circular wing structure 612. The end portion 618 has a second tapering portion 626 that tapers to the opening of the pass thru conduit 122.

Sample dimensions of the centerpiece 602 shown in FIG. 9c are exemplary of one embodiment of the nozzle 100. Other scales of the shown dimensions or different dimensions from those illustrated of the various parts may be implemented depending on the embodiment and/or application of the nozzle 100.

The housing 604 is shown in more detail in FIG. 9d. As seen in FIG. 9d, the housing 604 is cylindrical and forms a set of openings 630 positioned about its circumference. The set of openings 630 may be implemented as a single opening or a various number of openings. The set of openings 630 may have different sizes, shapes and positions depending on the particular application of the nozzle 100. In the embodiment shown in FIG. 9d, the set of openings 630 formed in the housing 604 are oval shaped and positioned parallel to each other around the circumference of the housing 604. The housing 604 also includes threads 632 at one end operable to couple the housing 604 to the threads 622 of the centerpiece 602. Other means of coupling the housing 604 and the centerpiece 602 may also be used, such as welding, adhesives, structural supports, etc.

FIG. 9e illustrates the hose attachment 606 in more detail. The hose attachment includes an inward extending lip 640 operable to couple to the lip 620 of the centerpiece 602. The hose attachment 606 includes threads 642 that are operable for attaching to threads of a hose or bail valve or other equipment. The hose attachment 606 may be various sizes depending on the application of the nozzle 100. For example, the hose attachment 606 may be sized such that the threads 642 are operable to attach to a standard size fire hose. In another embodiment, the hose attachment 606 may be sized such that the threads 642 are operable to attach to a standard size commercial or consumer water hose. The hose attachment 606 may also include one or more double sided thread pieces that are operable to be removably attached to the hose attachment 606. When attached to the hose attachment 606 by the threads on one side, the thread piece provides optimum size threads on the other side for a consumer water hose or a standard size commercial fire hose. When removed, the hose attachment 606 may be an optimum size for a different standard consumer water hose or different standard size fire hose. Various sized thread pieces may be removably coupled to the hose attachment to provide different optimum size threads for different type of hoses.

As seen in FIG. 9e, the hose attachment 606 includes an indentation 646 operable for placement of a washer. The washer would help provide a more water tight coupling between the hose attachment 606 and a hose. In an alternate embodiment, the hose attachment 606 may be attached to a bail valve or other piece of equipment depending on the application of the nozzle 100. Though the hose attachment 606 and the housing 604 are shown as separate parts, they may also be manufactured as a single part.

Referring back to FIG. 9a, the operation of this embodiment of the nozzle 100 is described in an application of a fire hose nozzle. In operation, the hose attachment 606 is coupled to the centerpiece 606 by the overlapping lip 640 of the hose attachment 606 and the lip 620 of the straightening vane piece 608. A fire hose or bail valve or other equipment for supplying high pressure water or water mixture is attached to the hose attachment 606 by the threads 642.

For attachment of the housing 604, the threads 622 of the straightening vane piece 608 are coupled to the threads 632 of the housing 604. The straightening vane piece 608 is sealed across the power fluid inlet 104, and the set of openings 630 formed in the housing 604 are positioned to extend across a portion of the straightening vane piece 608 and a portion of the support piece 610. In other embodiments, the set of openings 630 may be positioned to extend only across a portion of the straightening vane piece 608 or only across a portion of the support piece 610.

When fluid, such as water or a water mixture, enters the power fluid inlet 104, the fluid is forced into the set of openings 630. The straightening vane piece 608 thus operates to reduce a cross sectional area of the housing 604 in which the fluid may flow through the housing 604. Since the fluid passes through a reduced cross sectional area, the velocity of the fluid increases. With increasing flow velocity of the fluid, the pressure decreases. A portion of the volume of the power fluid 150 flows through the pass thru conduit (if present) at a high velocity and exits at the power fluid outlet 140. The remaining volume of the fluid flows through the straightening vanes 120. As this volume of fluid exits the straightening vanes 120 at a high velocity, due to viscous friction, a boundary layer of the fluid flows along the support piece 610. This high velocity fluid creates a low pressure area around the set of openings 630 drawing a fluid, such as air, into the housing 604. Then, when the fluid flow reaches the nose shaped profile 614 of the circular wing structure 612 at a high velocity, it impinges on the nosed shaped profile 614 and quickly decreases in velocity as it spreads across the entire volume of the housing 606. A portion of the fluid may circulate back around creating a circular flow around the mid section of the circular wing structure 612. This circular flow creates an area ideal for mixing the fluid and air that entered from the set of openings 630. The mixture of the fluid and air increases pressure at the tapering portion 616 of the circular wing structure but the velocity of the flow is further facilitated by the high velocity stream of a portion of the fluid exiting the pass thru conduit 122 at the power fluid outlet 140.

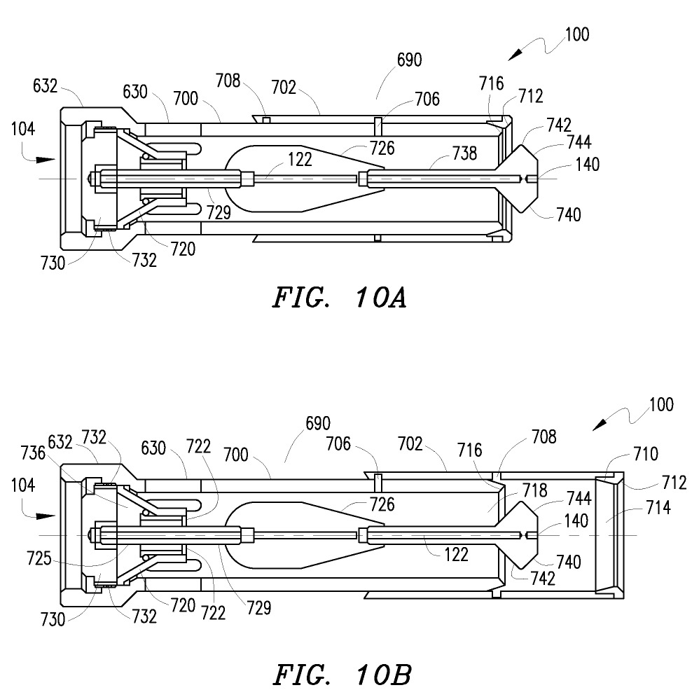

FIG. 10 illustrates another embodiment of the nozzle 100. This embodiment of the nozzle 100 comprises an adjustable housing 690 with a first portion 700 and a second extendable portion 702. The adjustable housing 690 is operable to adjust between a first extended position shown in FIG. 10a and a second retracted position shown in FIG. 10b. In one embodiment, a pin 706 and threads 708 are operable to threadably couple the first portion 700 and extendable portion 702. In one embodiment, the extendable portion is adjusted from the first retracted position to the second fully extended position by a half turn to provide for quick adjustment. The extendable portion 702 of the adjustable housing 690 also includes an inward angled wall 710 approximate to an outlet 714 of the housing 690 that curves to an outward angled wall 712 at the outlet 714.

The first portion 700 of the adjustable housing 690 includes a set of openings 630 and a hose attachment portion 632 that forms a power fluid inlet 104. In this embodiment the adjustable housing 690 and the hose attachment portion are one part, but as explained above, the hose attachment portion 632 may also be a separate part from the adjustable housing 690. The first portion 700 of the adjustable housing 690 also includes an outward angled wall 716 that forms a fluid outlet 718 of the first portion.

The centerpiece of the nozzle 100 in FIG. 9 may or may not include a pass thru conduit 122, as explained above. In this embodiment, the straightening vane piece 720 forms an opening 722 through its center wherein the opening has a greater diameter than a support piece 724. The support piece 724 is attached to hose attachment 632 by cross-sectional support pieces 730 that include threads 732 to couple with the hose attachment 632. The straightening vane piece 720 forms an inward conical space 736 to direct fluid flow into the narrower opening 722 of the straightening vane piece 720. Again, the straightening vane piece 720 is positioned across the power fluid inlet 104 and operates to reduce a cross sectional area of the adjustable housing 690 in which fluid may flow through the adjustable housing 690. Since the fluid passes through a reduced cross sectional area, the velocity of the fluid increases. With increasing flow velocity of the fluid, the pressure decreases. A portion of the volume of the fluid flows through the pass thru conduit (if present) at a high velocity and exits at the power fluid outlet 140. The remaining volume of the fluid flows through the opening 722 formed by the straightening vane piece 720. As this volume of fluid exits the straightening vane piece 720 at a high velocity, due to viscous friction, a boundary layer of the fluid flows along the support piece 724. This high velocity fluid creates a low pressure area around the set of openings 630 drawing a fluid, such as air, into the adjustable housing 690. This embodiment of the straightening vane piece 720 may also be used in other embodiments of the nozzle 100 described herein. In addition, the embodiment of the straightening vane piece 608 shown in FIG. 9 with straightening vanes 120 and pass thru conduit 1202 may be substituted in this embodiment of the nozzle 100 as well.

In the embodiment shown in FIG. 10, the centerpiece 726 includes a support piece 738 with a fixed spreader head 740. The sprayer head 740 forms no fluid passageways except for a pass thru conduit 122, if present, as described above. The sprayer head 740 has a bulging portion 742 that tapers outward and then a narrow portion 744 that tapers inwards. The sprayer head 740, support piece 738 and centerpiece 726 may be one part or may comprise two or more separate parts that are coupled.

In operation, when the extendable portion 702 of the adjustable housing 690 is retracted in the first position shown in FIG. 9a, the sprayer head 740 is positioned such that the outward bulging portion 742 is at least partially outside of the adjustable housing 690. In operation, the outward bulging portion 742 of the sprayer head 740 forces fluid outwards around the sprayer head 740. This outward flow of fluid is assisted by the outward angled walls 712 and 716 of the first portion 700 and extendable portion 702 of the adjustable housing 690. Thus, the sprayer head 740 creates a broad spray of fluid that is ideal, e.g. for a heat screen for entry to a burning area.

For a more concentrated spray of fluid, the extended portion 702 of the adjustable housing 690 is adjusted over the sprayer head 740 in the second position shown in FIG. 9b. In operation, the outward bulging portion 742 forces fluid outward around the sprayer head and increases the velocity of the fluid in the adjustable housing 690. The fluid is redirected to a more concentrated area by the inward angled wall 710 of the extended portion 702 of the adjustable housing and the inward bulging portion 744 of the sprayer head 740 within the adjustable housing 690. The ability of this embodiment of the nozzle 100 to quickly adjust the area of coverage of the fluid is ideal for fighting large fires where different capabilities may be quickly needed depending on the situation faced by a firefighter.

In each embodiment of the nozzle 100, the cross sectional area and number of the straightening vanes and pass thru conduit, if present, or the cross sectional area between the support piece and straightening vane piece along with the fluid pressure is proportional to the amount of fluid flow per time. As such, for example, the cross sectional areas and/or water pressure may be adjusted to obtain water flow through the nozzle 100 of a desired number of gallons per minute (GPM).

As used herein, the terms “substantial” or “substantially” or “approximate” or “approximately” provides an industry-accepted tolerance for its corresponding term and/or relativity between described parts. As may also be used herein, the term(s) “coupled to” and/or “coupling” includes direct coupling between parts and/or indirect coupling between parts via an intervening part. As may even further be used herein, the term “operable to” indicates that the described part comprises a necessary structure to perform one or more described functions of the part and may further include inferred coupling to one or more other parts to perform the described function.

The above embodiments are only one set of examples of the invention. These embodiments of the present invention have been described above with various functional parts, such as components, housings, pieces, supports and other structures illustrating the performance of certain significant functions of the present invention. The boundaries and dimensions of these various parts have been described for certain embodiments. Alternate boundaries and dimensions could be defined as long as certain significant functions of the invention are appropriately performed. One of average skill in the art will also recognize that the various parts, such as components, housings, pieces, supports and other structures herein, can be implemented as illustrated or by separate discrete components or by combining one or more of the parts into a single piece, without varying from the claimed invention. In addition, alternate methods for attaching the parts may be used from the methods described herein as long as certain significant functions of the invention are appropriately performed. In addition, though only a few applications have been described, various embodiments of the nozzle may be used in many different fields for different purposes. Various modifications of these embodiments, as well as alternative embodiments, will be suggested to those skilled in the art. The invention encompasses any modifications or alternative embodiments that fall within the scope of the claims.

1. A nozzle, comprising:
a cylindrical housing with a power fluid inlet and an outlet and a set of openings formed in the cylindrical housing between the power fluid inlet and outlet;
a straightening vane plate positioned across the power fluid inlet that operates to reduce a cross sectional area of the cylindrical housing in which fluid may flow through the cylindrical housing;
a support piece that extends from the straightening vane piece through the cylindrical housing; and
a circular wing structure coupled to the support piece, wherein the circular wing structure has a nosed shaped profile and tapering portion.

2. The nozzle of claim 1, wherein the set of openings are formed around a circumference of the cylindrical housing.

3. The nozzle of claim 2, further comprising an adjustable extension that retracts to shorten the cylindrical housing or extends forward to lengthen the cylindrical housing.

4. The nozzle of claim 3, further comprising a sprayer head extending from the circular wing structure.

5. The nozzle of claim 4, wherein the sprayer head is positioned within the adjustable extension when the adjustable extension is extended.

6. The nozzle of claim 5, wherein the sprayer head is positioned outside the adjustable extension when the adjustable extension is retracted.

7. The nozzle of claim 6, wherein the set of openings formed in the cylindrical housing are positioned to extend at least partially across the straightening vane plate.
